(19) United States
(12) Patent Application Publication
(10) Pub. No.: US 2025/0279672 A1
(43) Pub. Date: Sep. 4, 2025

(54) SYSTEMS AND METHODS FOR WORKSITE GEOGRAPHIC OPTIMIZATION

(71) Applicant: Caterpillar Inc., Peoria, IL (US)

(72) Inventors: Srideep Chatterjee, Bhopal (IN); L S N V A Vinaykumar Gullapudi, Koyyalagudem (IN); Prakash Prashanth Ravi, Bangalore (IN)

(73) Assignee: Caterpillar Inc., Peoria, IL (US)

(21) Appl. No.: 18/592,764

(22) Filed: Mar. 1, 2024

(51) Int. Cl. H02J 13/00; H02J 7/00

(52) U.S. Cl. CPC H02J 13/00006; H02J 7/00032; H02J 7/0013; H02J 7/0047; H02J 7/00712

(57) ABSTRACT

Systems and methods for worksite geographic optimization may include one or more processors configured to calculate a worksite metric for a first worksite layout, the worksite metric based on a worksite cost and a historic worksite metric during a previous time period. In some embodiments, the first worksite layout differs from a second worksite layout. The processor(s) calculate a score corresponding to a machine at the first worksite layout, and select a charging location for the machine at the first worksite layout, according to the score and the worksite metric. The processor(s) can transmit a first signal corresponding to the charging location to the first machine, and a second signal to a charger of the plurality of chargers at the charging location.

### TECHNICAL FIELD

The present implementations relate generally to optimizing locations of chargers at a worksite.

### INTRODUCTION

The present disclosure relates generally to optimizing locations of chargers at a worksite. Worksites, such as construction sites, manufacturing plants, mining sites, and agricultural sites, may require machines to charge on the worksite.

### SUMMARY

This disclosure is generally directed to optimizing locations of chargers at a worksite. With the introduction of electrified machines in a worksite, there is an increased need for optimally placed chargers at a worksite. By not moving chargers based on the worksite, issues of reduced productivity, increased energy demand, poor scheduling, increased project timelines and increase cost at the worksite arise. Aspects of this technical solution can provide a method for optimizing charger locations at a worksite to improve productivity, reduce energy demand, reduce scheduling issues, and reduce the cost at the worksite. For example, optimizing locations of chargers allows for a method that can include calculating, by one or more processors of a distributed controller, a worksite metric for a first worksite layout, the worksite metric based on a worksite cost and a historic worksite metric during a previous time period, wherein the first worksite layout differs from a second worksite layout. The method can include calculating, by the one or more processors of the distributed controller, a score corresponding to a machine at the first worksite layout. The method can include selecting, by the one or more processors of the distributed controller, a charging location for the machine at the first worksite layout, according to the score and the worksite metric. The method can include transmitting, by the one or more processors of the distributed controller, the charging location to the machine and to a charger at the charging location at the first worksite layout.

A first aspect provided herein relate to a method of worksite geographical optimization at a worksite. The method can include the one or more controllers calculating a worksite metric for a first worksite layout, the worksite metric based on a worksite cost and a historic worksite metric during a previous time period. In some embodiments, the first worksite layout differs from a second worksite layout. The method can include the one or more controllers calculating a score corresponding to a machine at the first worksite layout. The method can include the one or more controllers selecting a charging location for the machine at the first worksite layout, according to the score and the worksite metric. The method can include the one or more controllers transmitting a first signal corresponding to the charging location to the machine, and a second signal to a charger at the charging location.

In some embodiments, the method can include the one or more controllers calculating the worksite cost, based on a difference between a total cost and an amount of energy spent by the machine to reach the charger at the second worksite layout, during the previous time period. In some embodiments, the method can include the one or more controllers calculating the historic worksite metric based on a difference between a total amount of work and an amount of productive work at the second worksite layout, during the previous time period.

In some embodiments, the battery metrics can indicate at least one of a state of charge, a state of health, a voltage, charging time, or safety parameters. In some embodiments, the method can include the one or more controllers determining, the charging location based on the first worksite layout, movement of materials, and movement of the machine. In some embodiments, the method can include the one or more controllers determining the charger according to the charging location, and a path to the charger according to first worksite layout. In some embodiments, the method can include the one or more controllers transmitting a signal to the machine. In some embodiments, the signal can indicate the machine follow the path to the charger. In some embodiments, the signal can include information corresponding to load cycles and energy generation of the charge based on the previous time period.

In some embodiments, the method can include the one or more controllers receiving information between one or more machines and one or more chargers from a central controller. In some embodiments, the information can indicate battery metrics and charger availability. In some embodiments, the method can include the one or more controllers computing, using a linear optimizer, a new charger location for a future time period, according to the worksite cost and the historic worksite metric.

In some embodiments, the method can include the one or more controllers receiving a machine criticality at the first worksite layout corresponding to the machine, a queue at the charger, a charger connection success rate, and a time to charge based on a cost of energy from a central controller. In some embodiments, the method can include the one or more controllers calculating the score corresponding to the machine, according to the machine criticality, the queue at the charger, the charge connection success rate, and the time to charge.

In some embodiments, the method can include the one or more controllers sending the score to the charger and receiving an acceptance of the score by the charger. In some embodiments, the method can include the one or more controllers transmitting a signal to the machine. In some embodiments, the signal directs the machine to proceed to the charger of the received acceptance. In some embodiments, the method can include the one or more controllers broadcasting charger information of the charger of the received acceptance to a plurality of machines. In some embodiments, charger information can indicate an availability status and a power availability, each bid in the plurality of bids indicate battery metrics of a corresponding machine. In some embodiments, the method can include the one or more controllers receiving a plurality of bids from the plurality of machines and determining one bid in the plurality of bids corresponding to the charger information to charge the corresponding machine.

A second aspect provided herein relate to a system for worksite geographical optimization at the worksite. A system can include a plurality of machines. The plurality of machines can include one or more first machines at a first operation location and one or more second machines at a second operation location. The system can include a plurality of chargers. The plurality of chargers can include one or more first chargers at a first charging location and one or more second chargers at a second charging location. The system can include a data processing system. The data processing system can include memory and one or more controllers. The controller(s) can include one or more processors that can calculate a worksite metric for a first worksite layout. The worksite metric can be based on a worksite cost and a historic worksite metric during a previous time period. In some embodiments, the first worksite layout differs from a second worksite layout. The one or more processors can calculate a score corresponding to a first machine of the plurality of machines at the first worksite layout. The one or more processors can select a charging location for the machine at the first worksite layout, according to the score and the worksite metric. The one or more processors can transmit a first signal corresponding to the charging location to the first machine, and a second signal to a charger of the plurality of chargers at the charging location.

In some embodiments, a central controller of the one or more controllers can calculate the worksite cost, based on a difference between a total cost and an amount of energy spent by the first machine to reach the charger at the second worksite layout, during the previous time period. In some embodiments, the central controller can calculate the historic worksite metric based on a difference between a total amount of work and an amount of productive work at the second worksite layout, during the previous time period.

In some embodiments, the battery metrics can indicate at least one of a state of charge, a state of health, a voltage, charging time, or safety parameters. In some embodiments, a distributed controller of the one or more controllers can determine the charging location based on the first worksite layout, movement of materials, and movement of the first machine. In some embodiments, the distributed controller can determine the charger according to the charging location and a path to the charger according to the first worksite layout. In some embodiments, the distributed controller can transmit a signal to the first machine. In some embodiments, the signal can instruct the first machine follow the path to the charger. In some embodiments, the signal can indicate load cycles and energy generation of the charger based on the previous time period.

In some embodiments, a distributed controller of the one or more controllers can receive information between one or more of the plurality of machines and one or more of the plurality of chargers from a central controller. In some embodiments, the information can indicate battery metrics and charger availability. In some embodiments, the one or more controllers can compute, using a linear optimizer, a new charger location for a future time period, according to the worksite cost and the historic worksite metric. In some embodiments, the one or more controllers can determine a third worksite layout based the new charger location.

In some embodiments, a distributed controller of the one or more controllers can receive a machine criticality at the first worksite layout corresponding to the first machine, a queue at the charger, a charger connection success rate, and a time to charge, and calculate the score corresponding to the first machine, according to the machine criticality, the queue at the charger, the charge connection success rate, and the time to charge.

In some embodiments, a distributed controller of the one or more controllers can send the score to the charger and receive an acceptance of the score by the charger. In some embodiments, the distributed controller can transmit the first signal to the first machine. In some embodiments, the first signal directs the machine to proceed to the charger of the received acceptance. In some embodiments, the distributed controller broadcast charger information of the charger of the received acceptance to a plurality of machines. In some embodiments, charger information can indicate an availability status and a power availability. In some embodiments, the distributed controller can receive a plurality of bids from the plurality of machines. In some embodiments, each bid in the plurality of bids can indicate battery metrics of a corresponding machine. In some embodiments, the distributed controller can determine one bid in the plurality of bids corresponding to the charger information to charge the corresponding machine.

In some embodiments, the one or more controllers include a central controller and a distributed controller. The distributed controller may calculate the worksite metric for the first worksite layout, and calculate the score corresponding to the first machine of the plurality of machines at the first worksite layout. The distributed controller may select the charging location for the first machine at the first worksite layout, according to the score and the worksite metric. The distributed controller may transmit the first signal corresponding to the charging location to the machine, and the second signal to the charger at the charging location.

In a third aspect, this disclosure is directed to a data processing system including memory and one or more controllers including one or more processors configured to calculate a worksite metric for a first worksite layout, the worksite metric based on a worksite cost and a historic worksite metric during a previous time period. The first worksite layout may differ from a second worksite layout. The controller(s) may be configured to calculate a score corresponding to a first machine of a plurality of machines at the first worksite layout. The controller(s) may be configured to select a charging location for the first machine at the first worksite layout, according to the score and the worksite metric. The controller(s) may be configured to transmit a first signal corresponding to the charging location to the first machine, and a second signal to a charger of a plurality of chargers at the charging location.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 depicts an example system to implement geography optimization at a worksite, in accordance with present implementations.

FIG. 2 depicts an example worksite layout, in accordance with present implementations.

FIG. 3 depicts an example data processing system to implement geography optimization at the worksite, in accordance with present implementations.

FIG. 4 is a flowchart showing an example method to implement geography optimization for the worksite, in accordance with present implementations.

### DETAILED DESCRIPTION

This disclosure is generally directed to optimizing locations of chargers at a worksite. With the introduction of electrified machines in a worksite, there is an increased need for optimally placed chargers at a worksite. By not moving chargers based on the worksite, issues of reduced productivity, increased energy demand, poor scheduling, increased project timelines and increase cost at the worksite arise. Aspects of this technical solution can provide a method for optimizing charger locations at a worksite to improve productivity, reduce energy demand, reduce scheduling issues, and reduce the cost at the worksite. For example, optimizing locations of chargers allows for a method that can include calculating, by one or more processors, a worksite metric for a first worksite layout, the worksite metric based on a worksite cost and a historic worksite metric during a previous time period, wherein the first worksite layout differs from a second worksite layout. The method can include calculating, by the one or more processors, a score corresponding to a machine at the first worksite layout. The method can include selecting, by the one or more processors, a charging location for the machine at the first worksite layout, according to the score and the worksite metric. The method can include transmitting, by the one or more processors, the charging location to the machine and to a charger at the charging location at the first worksite layout.

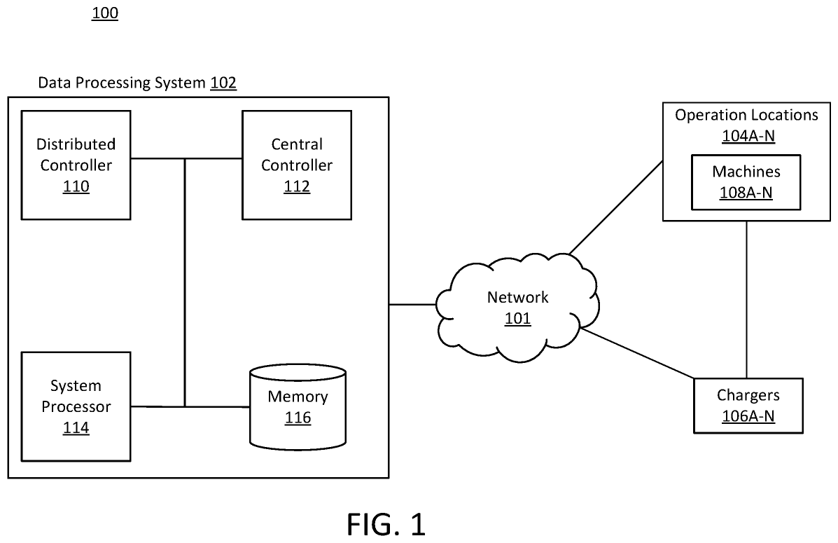

FIG. 1 depicts an example system 100 to implement worksite dynamic charging at a worksite. The system 100 can include a data processing system 102, operation locations 104A-N (referred to as operation locations 104 herein), and chargers 106 A-N (referred to as chargers 106 herein). The above-mentioned components may be communicably connected to each other through a network 101. The examples of the network 101 may include, but are not limited to, private or public local area network (LAN), wireless local area network (WLAN), metropolitan area network (MAN), wide area network (WAN), and so forth, which may be used to communicate either via peer-to-peer or via the Internet. The network 101 may include or support both wired and wireless communications according to one or more standards and/or via one or more transport mediums.

The communication over the network 101 may be performed in accordance with various communication protocols such as Transmission Control Protocol and Internet Protocol (TCP/IP), User Datagram Protocol (UDP), and IEEE communication protocols. In one example, the network 101 may include wireless communications according to Bluetooth specification sets, or another standard or proprietary wireless communication protocol. In another example, the network 101 may also include communications over a cellular network, including, e.g., a GSM (Global System for Mobile Communications), CDMA (Code Division Multiple Access), EDGE (Enhanced Data for Global Evolution) network.

The system 100 is not confined to the components described herein and may include additional or alternate components, not shown for brevity, which are to be considered within the scope of the embodiments described herein.

The system 100 can include at least one data processing system 102. The data processing system 102 can include a physical computer system operatively coupled or that can be coupled with one or more components of the system 100, either directly or through an intermediate computing device or system. The data processing system 102 can include a virtual computing system, an operating system, and a communication bus to effect communication and processing. The data processing system 102 can include a distributed controller 110, a central controller 112, a system processor 114, and memory 116.

The system 100 can include at least one memory 116 within the data processing system 102. The memory 116 can be coupled to the distributed controller 110, the central controller 112, and the system processor 114. The memory 116 can store data associated with the system 100. The memory 116 can include one or more hardware memory devices to store binary data, digital data, or the like. The memory 116 can include one or more electrical components, electronic components, programmable electronic components, reprogrammable electronic components, integrated circuits, semiconductor devices, flip flops, arithmetic units, or the like. The memory 116 can include at least one of a non-volatile memory device, a solid-state memory device, a flash memory device, and a NAND memory device. The memory 116 can include one or more addressable memory regions disposed on one or more physical memory arrays. A physical memory array can include a NAND gate array disposed on, for example, at least one of a particular semiconductor device, integrated circuit device, or printed circuit board device.

The distributed controller 110, the central controller 112, and the system processor 114 (referred to as the controllers) of the system 100 can execute one or more instructions associated with the data processing system 102. The controllers can include an electronic processor, an integrated circuit, or the like including one or more of digital logic, analog logic, digital sensors, analog sensors, communication buses, volatile memory, nonvolatile memory, and the like. The controllers can include, but are not limited to, at least one microcontroller unit (MCU), microprocessor unit (MPU), central processing unit (CPU), graphics processing unit (GPU), physics processing unit (PPU), embedded controller (EC), or the like. The controllers can include memory operable to store or storing one or more instructions for operating components of the controllers and operating components operably coupled to the controllers. For example, the one or more instructions can include one or more of firmware, software, hardware, operating systems, embedded operating systems. The controllers or the data processing system 102 generally can include one or more communication bus controllers to effect communication between the controllers and the other elements of the data processing system 102.

The system 100 can include one or more chargers 106A-N (referred to as chargers 106 herein) at a worksite. The chargers 106 can be connected to one or more power sources, such as electrical outlets, generators, or power supply units, among others. For example, a charger 106A can be connected to a microgrid to receive electrical power. The chargers 106 can provide electrical energy to batteries, electrical tools, and/or machines 108A-N (referred to as the machines 108 herein). For example, a power tool can connect to a charger 106A to recharge a battery of the power tool. The chargers 106 can charge the machines 108 during a workday or outside of operational hours. For example, a machine 108A can charge at a charger 106 overnight at a worksite.

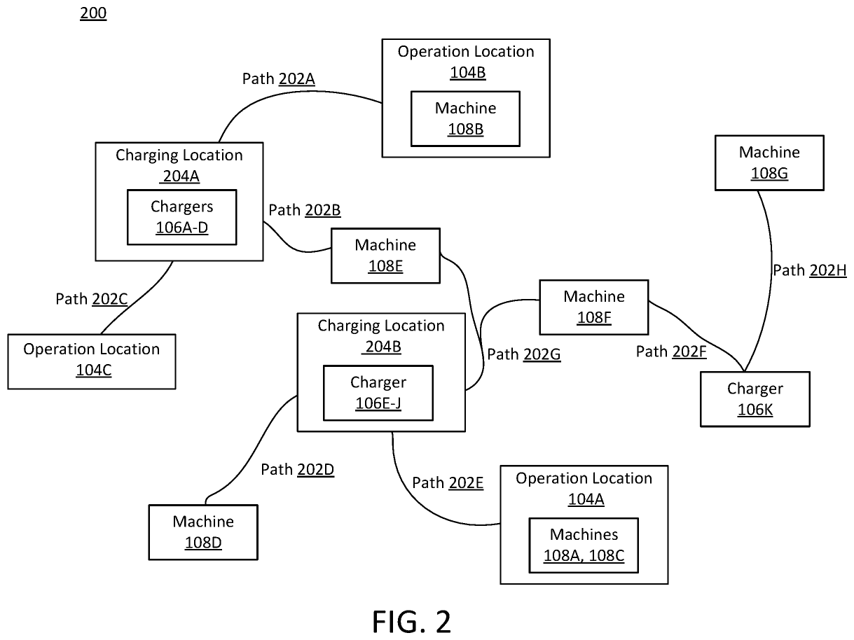

The system 100 can include one or more operation locations 104. The operation location 104 can be or include a designated or specific area within the worksite, where a plurality of activities corresponding to the work environment take place. For example, at a construction site, an operation location 104 can be an excavation site or a building assembly. In another example, at mining site, an operation location 104 can be an area or location where mineral/material/fluids/ore extraction occurs. Each operation location 104 can include one or more machines 108. For example, referring briefly to FIG. 2, an operation location 104B can include machine 104B. In another example, an operation location 104A can include machines 108A and 108C. In yet another example, an operation location 104C may not include any machines 108.

Referring back to FIG. 1, the system 100 can include at least one distributed controller 110 within the data processing system 102. In some embodiments, each machine 108 at the worksite can include the distributed controller 110. For example, a first machine 108B can include a first distributed controller 110 and a second machine 108F can include a second distributed controller 110. The distributed controller 110 can gather data associated with the worksite. The distributed controller 110 can be configured to communicate with one or more sensors to collect the data associated with the worksite. For example, one or more sensors can gather data regarding equipment usage, fuel consumption, project progress, and environmental conditions. In some arrangements, the distributed controller 110 can communicate with one or more devices to gather the data. For example, a distributed controller 110 can communicate with various devices, such as GPS devices, RFID tags, sensors on machines 108, and cameras to gather data.

The distributed controller 110, the central controller 112 or the system processor 114 can analyze the data and convert the data into a usable format. For example, a camera can transmit a video of the movement of a machine 108A, during a workday, to a distributed controller 110. The distributed controller 110 can process the video to extract relevant data (e.g., time of the movement, distance traveled of the machine, etc.). In another example, a sensor on a machine 108A can report usage of the machine 108A to a distributed controller 110. The distributed controller 110 can use the usage of the machine 108A in one or more formulas to convert the data into a metric. The distributed controller 110 can store the metric and the data in the memory 116 for use during a future time period. For example, the distributed controller 110 can store a usage for a machine 108A in memory 116. The system processor 114 can extract the usage for the machine 108A to form a schedule for the machine 108A.

The distributed controller 110, the central controller 112, or the system processor 114 can calculate the metric for the worksite layout. Referring now to FIG. 1 and FIG. 2, FIG. 2 depicts an example worksite layout 200. The worksite layout 200 can include one or more operation locations 104, chargers 106, machines 108, paths 202A-N (referred to as “paths 202” or “path 202” herein) and charging locations 204A-N (referred to as “charging locations 204” or “charging location 204” herein). The worksite layout 200 is shown as an example and can change daily, weekly, or monthly among others. For example, in worksite layout 200 on a first date, a machine 108B can be in an operation location 104B, whereas in worksite layout 200 on a subsequent or different date, a machine 108A can be in the operation location 104B.

The worksite layout 200 can include at least one path 202. The path 202 can be or include a route from the machines 108 to the charging locations 204. For example, a path 202G can lead a machine 108F to the charging location 204B. Some paths 202 can be a route between the operation location 104 and the charging location 204. For example, a path 202A an connect an operation location 104B with a charging location 204A. Some paths 202 can be a route from the machine 108 to the charger 106. For example, a path 202H can lead a machine 108G to a charger 106K. The worksite layout 200 can include at least one charging location 204. The charging locations 204 can include one or more chargers 106. For example, a charging location 204B can include one or more chargers 106E-J.

Referring again to FIG. 1, as noted above, the distributed controller 110, the central controller 112, or the system processor 114 can calculate metric(s) for the worksite layout. In some embodiments, the metric can include productivity metrics, resource utilization, cost, safety metrics, and environment impact, among others. For example, a productivity metric can be based on the amount of work completed, time taken to complete the amount of work, and the number of resources used during the time. In another example, resource utilization can indicate how efficiently equipment and labor are used at the worksite. In yet another example, an environmental impact can access an impact of the worksite on the surrounding environment. The metric can be a percentage, a rate, a numerical value, or on-time task completion. For example, a metric indicate a percentage of budget used during a workday at a worksite.

The distributed controller 110 or the central controller 112 can base the metric on the cost at the worksite and a historic worksite metric. The distributed controller 110 or the central controller 112 can use one or more formulas or algorithms to combine the cost and the historic worksite metric. For example, a formula can be a cost at the worksite multiplied by a historic worksite metric. In another example, a formula for the cost can be units produced divided by hours worked multiplied by the hourly rate. In yet another example, a formula for a historic worksite metric can be based on a summation of previous history worksite metrics.

The cost at the worksite can be an estimation based on one or more factors during a previous time period (e.g., yesterday, last week, last month). The one or more factors can include the cost of the worksite during a previous time period and an amount of energy spent for the respective machine 108 to reach the respective charger 106 at the worksite layout 200 during the previous time period. For example, a cost at a worksite today can be based on a difference between the cost at the worksite yesterday and an amount of energy spent by a machine 108A to reach a charger 106A at the worksite layout 200 yesterday. In some arrangements, the cost at the worksite can be an estimation based on the project. The project can require the worksite layout 200 to be the same over an extended period of time (e.g., weeks, months, years, etc.). For example, the worksite layout 200 can be the same from Oct. 22, 2022-Mar. 15, 2023. A cost at the worksite can a value based on the stages of the project from Oct. 22, 2022-Mar. 15, 2023. Thus, within the stages of the project, the cost at the worksite can be the same.

The distributed controller 110 or the central controller 112 can calculate the historic worksite metric, based on a difference between a total amount of work and an amount of productive amount of work at a worksite layout 200 of the previous time period. The total amount of work can be based on one or more factors such as a collection of resources used, an amount of energy spent by the machines 108 at the one or more operation locations 104, an amount of energy spent by the machines 108 at the worksite, an amount of energy spent by the chargers, progress toward the completion of a project for the worksite, or total cost of the worksite, among others. For example, a total amount of work can be based on an amount of energy spent by a machine 108A at an operation location 104A. The amount of productive work at the worksite layout 200 of the previous time period can be based on the same factors as the total amount of work, although the factors must progress toward the completion of the project at the worksite. For example, a machine 108 traveling to the incorrect operation location 108A can add to a total amount of work but may not contribute to an amount of productive work. Conversely, a machine 108 traveling to the correct operation location 108A can add to a total amount of work and to an amount of productive work.

In some arrangements, the distributed controller 110 or the system processor 114 can calculate new charging locations 204 using a linear optimizer. The linear optimizer can be a mathematical algorithm to find an optimal outcome. The linear optimizer can be configured to compute or execute an objective function (e.g., worksite cost, historic worksite metric) to estimate necessary parameters for a future time period. For example, the liner optimizer can be configured or executed to find an optimal worksite cost (e.g., using a cost function). In another example, a linear optimizer can be used to find an optimal historic worksite metric. The new charging location 204 can be for a future time period. The distributed controller 110 or the system processor 114 can use the historic work metric and worksite cost to find new charging location 204 to reduce the worksite cost and improve the historic worksite metric. For example, a new charging location 204C can be closer to operational location 104A to reduce the worksite cost for movement of machine 108D. In another example, a new charging location 204D can be closer to operational location 104B and operational location 104A to improve a historic worksite metric of a worksite 200. The distributed controller 110 or the system processor 114 can determine a new worksite layout 200 based on the new charging locations 204.

The distributed controller 110 or the central controller 112 calculate a score corresponding to the one or more machines 108. The score can be calculated using one or more factors according to the work layout. The factors can include at least one of distance from the respective machine 108 to the respective charger 106, amount of energy consumed by the respective machine 108 to reach the respective charger 106, charge power needed, charger 106 capability, charge time needed, charger 106 uptime, time to charge, and cost of energy at that time. For example, the score can be based on a distance from a machine 108A to a charger 108A, a time for the machine 108A to charge, and the charger 106 capability. In another example, the score can be based on an amount of energy consumed by a machine 108A to reach the charger 106A, the charger 106 capability, and a charge time needed for the machine 108A.

The distributed controller 110 can calculate the score corresponding to the machine, according to a machine criticality, a queue, a charge connection success rate, and a time to charge. The distributed controller 110 can receive the machine criticality at the worksite layout 200 corresponding to the machine 108. The machine criticality can indicate an impact relating to downtime for the machines 108. For example, a machine 108A can transmit a machine criticality to a distributed controller 110 to identify one or more conditions in which the machine 108A has experienced downtime (e.g., time in which the machine 108A is idle, not being used, inactive, disabled, lacks power, etc.).

The distributed controller 110 can receive the queue at the charger 106 from the central controller 112. The queue at the charger 106 can indicate one or more machines 108 requesting to charge at the charger. For example, a queue at charger 106B can include a first machine 108B, a second machine 108E, a third machine 108D and a fourth machine 108C. The distributed controller 110 can receive the charger connection success rate from the central controller 112. The charger connection success rate can indicate that one or more chargers 106 are functioning properly. In one example, a charger 106C can have a charger success rate of 85%, indicating that the charger 106C can be connected to one or more machines 108, but may not be successfully connected to at least one machine 108. In some embodiments, the charger success rate may indicate a likelihood of successful connection to a machine 108 (e.g., based on how many instances in which the charger 106 was unable to successfully connect for charging). The distributed controller 110 can receive a time to charge based on a cost of energy from the central controller 112. For example, to reduce a worksite cost, a central controller 112 can send a time to charge to a distributed controller 110.

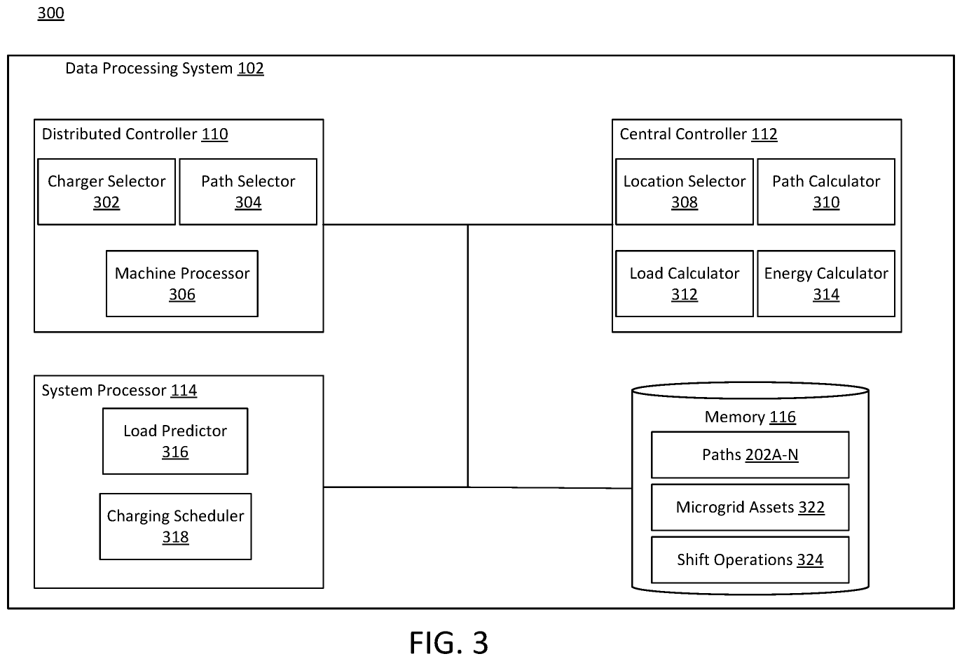

Referring now to FIG. 1 and FIG. 3, FIG. 3 depicts an example data processing system 102 to implement geography optimization at the worksite. The central controller 112 can include a location selector 308, a path calculator 310, a load calculator 312, and an energy calculator 314. The location selector 308 can select the charging location 204 based on various factors described herein. The factors can include but are not limited to the worksite layout 200, battery metrics, movement of machines, and movement of materials among others. The path calculator 310 can calculate a path 202 corresponding to the worksite layout 200. The path calculator 310 can calculate the path 202 based on the worksite layout 200, location of machines 108, location of chargers 106, location of the operation locations 104, among others. The load calculator 312 can calculate a load for the machines 108. For example, a load calculator 312 can calculate the loads of machine 108A, machine 108B, and machine 108C. The load can be calculated using a weight for the respective machines, energy spent of a machine, or a terrain for a worksite layout 200. In some arrangements, the load can impact the score for the machines 108. For example, a load calculator 312 can calculate a higher load for a machine 108A. Thus, the score for the machine 108A can increase because of the higher load.

The energy calculator 314 can calculate a predicted energy usage or a continuous energy usage. The predicted energy usage can use a load predictor 316 of the system processor 114. The load predictor 316 can predict a load for the machines 108 at the start of the day at the worksite layout 200. For example, a load predictor 316 can estimate a load for a bulldozer at a worksite 200 (e.g., based on one or more shifts or related stored information identifying predicted or expected usage of the bulldozer at the worksite 200 within a particular time period). Thus, an energy calculator 314 of the central controller 112 can use the load to calculate a predicted energy usage. The predicted energy usage can use a charging scheduler 318 of the system processor 114. The charging scheduler 318 can leverage shift operations 324 in memory 116 to determine a schedule to charge the machines 108 based the predicted load for the machines 108. The shift operations 324 can correspond to a plurality of tasks for the machines 108 at the worksite. For example, a machine 108A may have shift operations 324 corresponding to excavation and transportation of materials. Based on the shift operations 324, a charging scheduler 318 can determine a schedule to charge the machine 108A.

The location selector 308 of the central controller 112 can select a charging location 204 for the respective machine 108 at the worksite layout 200. The charging location 204 can be a location in which one or more chargers 106 are located. For example, a charging location 204 can include a charger 106A. In another example, a charging location 204A can include a first charger 106A and a second charger 106B. The location selector 308 may be configured to select, compute, or otherwise determine the charging location 204, based on the calculated score and the calculated worksite metric. For example, the location selector 308 can use a score and a worksite metric for a machine 108E to select charger 106A or charger 106B. In another example, a location selector 308 of the central controller 112 can use a score and a worksite metric for a machine 108B to select charger 106A. In yet another example, a location selector 308 of the central controller 112 can use a score and a worksite metric for a machine 108F to select charger 106C.

The location selector 308 can select the charging location 204 based on battery metrics of the respective machine 108 and an availability of chargers 106. The battery metrics can indicate a state of charge, a state of health, a voltage, a charging time, or maintenance parameters. For example, a very low state of charge can indicate that a machine 108A can only travel to the closest charger 106A. In another example, a high state of charge can indicate that a machine 108A can travel to a charger 106A that is farther away from the machine 108A. In yet another example, a machine 108A with maintenance parameters can indicate that the machine 108A will need maintenance prior to traveling to a charger 106A. In some arrangements, the battery metrics can impact the score for the respective machine 108A. For example, a machine 108A having batteries which are outputting a low voltage (e.g., indicating that the batteries are close to depleted) can have an increased score. In another example, a machine 108A with a low charging time can have a reduced score.

The location selector 308 can select the charging location 204 based on the worksite layout 200. In some embodiments, the location selector 308 may be configured to maintain or otherwise access data corresponding to the worksite layout 200. The location selector 308 may, for example, access a map (e.g., geographic and/or terrain map) which includes data corresponding to locations of various components or elements of the worksite. As, for example, machines 108 move about the location, the location selector 308 may be configured to update the map (e.g., in real-time or substantially real-time) according to the changes in location. In some instances, a worksite layout 200 can include a terrain that can cause the one or more machines 108 to use a higher amount of energy travel to the one or more chargers 106. For example, a charger 106K can be on top of a hill and can be the closest charger 106 to a machine 108G. Thus, the location selector 308 can select a charger 106E to reduce an amount of energy spent by the machine 108G when traveling to the selected charger 106E. The worksite layout 200 can include one or more charging locations 204 with a high availability of chargers 106. Thus, the location selector 308 can select the charging location 204 based on the worksite layout 200 and the availability of the chargers 106. For example, a charging location 204A can have a high availability of chargers 106A-K (e.g., based on none of the chargers 106A-K being currently used to charge a machine 108), whereas a charging location 204B can have a low availability of chargers 106L-O (e.g., based on most [or all] chargers being currently used to charge a machine 108). Therefore, a location selector 308 of the central controller 112 can select the charging location 204A, even though fewer chargers are present at charging location 204A relative to charging location 204B.

The location selector 308 can select the charging location 204 based on a movement of materials and a movement of the machines 108. The materials for the worksite layout 200 can change based on the worksite layout 200. For example, materials for a demolition worksite layout 200 can be different from the materials of an excavation worksite layout 200. In some arrangements, the materials can move between operation locations 104 along one or more paths 202. For example, if materials need to be moved from operation location 104A to operation location 104B along path 202G, path 202B, and path 202A, a location selector 308 of the central controller 112 can select a charging location 204B or charging location 204A along the respective paths 202. The movement of the machines 108 can change based on the worksite layout 200 and the operation locations 104. For example, a machine 108G may travel to operation location 104C along path 202H, path 202E, path 202G, path 202B, and path 202C respectively. Thus, a location selector 308 of the central controller 112 can select a charging location 204 along the path 202.

The central controller 112 can transmit the charging location 204 to the distributed controller 112. The distributed controller 110 can include at least one charger selector 302, path selector 304, and machine processor 306. The charger selector 302 can determine the charger 106 according to the charging location 204. For example, a location selector 308 can select charging location 204A at a worksite 200. The charger selector 302 can leverage the availability of chargers 106A-D at the charging location 204A to select charger 106B for a machine 108A. In another example, a location selector 308 can select charging location 204A at a worksite 200. The charger 302 can leverage the availability of chargers 106A-D at the charging location 204A to select a first charger 106A or a second charger 106B for a machine 108A. In some arrangements, the charger selector 302 can determine the charger 106 not according to the charging location 204. For example, a charging selector 302 of a distributed controller 110 can leverage the availability of chargers 106A-K at the worksite 200 to select charger 106K for a machine 108A.

The path selector 304 can determine the path 202 to the charger 106 according to the worksite layout 200. To determine the path 202 to the charger 106, the path selector 204 can use the path calculator 310 of the central controller 112. The path selector 304 can select the path 202 which is the best path 202 for the machines 108 to reach the charger 106. For example, a path calculator 310 can calculate paths 202A-H for a worksite layout 200. A path selector 304 of a machine 108A can select path 202E, path 202G, and path 202F to reach charger 106K.

The machine processor 306 can transmit a signal to the machines 108. In some embodiments, such as where the distributed controller 110 is provided at each machine 108, the signal can be sent directly to the machine 108. Otherwise, the signal is sent from the distributed controller 110 over the network 101 to the machine 108. The signal can indicate or trigger the machines 108 to follow the path 202 to the charger 108. For example, a machine processor 306 can transmit a signal to a machine 108D. In response to receiving the signal, the machine 108D may follow path 202D to a charger 106E. The signal can include information corresponding to load cycles of the machine 108 and energy generation/storage at the charger 106. For example, a signal from the machine processor 306 can indicate load cycles for a machine 102G to travel to charger 106K along path 202H. Furthermore, the signal can indicate an amount of energy stored at the charger 106K.

The machine processor 306 can transmit the score to the selected charger 106. The selected charger 106 can receive a plurality of scores from the machine processors at the machines 108. For example, a first machine 108A, a second machine 108B, and third machine 108C can each send a score to charger 106J. The distributed controller 110 can receive an acceptance of the score by the chargers 106 and transmit a signal to the machines 108. The acceptance of the score can indicate that the machines 108 can proceed to the chargers 106. For example, a distributed controller 100 can receive an acceptance of a score from charger 106K and the distributed controller 110 can send a signal to allow a machine 108G to proceed to the charger 106K. In some arrangements, the chargers 106 can reject the score of the machines 108. For example, if a queue of a charger 106A is too larger, the charger 106A can reject a score of a machine 108A.

The central controller 112 can broadcast charger information of the acceptance of the score to the plurality of machines 108. The charger information can indicate an availability status and power availability of microgrid assets 322 in memory 116. The microgrid assets 322 can correspond to the amount of power available at a power grid from the worksite 200. The microgrid assets 322 can include utilities, generator sets, and renewable energy sources. The availability status can indicate how available the chargers 106 are throughout the workday. For example, a first charger 106A with a low availability indicates that the first charger 106A is not available during a workday, whereas a second charger 106B with a high available indicate that the second charger 106B is available during the day. In response to broadcasting the charger information, the plurality of machines 108 can transmit a plurality of bids to the central controller 112. Each bid in the plurality of bids can include a request to charge the corresponding machine 108. For example, a plurality of machines 108A-N can send a plurality of bids to a central controller 112. The central controller 112 can determine one bid in the plurality of bids corresponding to the charger information, to charge the corresponding machine 108 at the respective charger 106. For example, a plurality of machines 108A-N can send a plurality of bids to a central controller 112 for a charger 106C. The central controller 112 can determine that a first machine 108C of the plurality of machines 108 can proceed to the charger 106C.

The distributed controller 110 can transmit the charging location to the respective machine 108. Each machine 108 in the one or more machines 108 can include a distributed controller 110 to allow for communication over the network 101. The distributed controller 110 can transmit the charging location using the network 101 or using a hard wired connection with the machine 108. For example, a distributed controller 110 can transmit a charging location to a machine 108 through a hardwired connection with the machine 108A. In another example, a distributed controller 110 of a first machine 108A can transmit a charging location to a distributed controller 110 of a second machine 108B to broadcast the charging location to one or more machines 108 at the worksite.

The distributed controller 110 can transmit the charging location to the respective charger 106. The distributed controller 110 can transmit the charging location to the one or more chargers 106 using the network 101. For example, a distributed controller 110 of a machine 108E can transmit a charging location to chargers 106A-D. In another example, a distributed controller 110 of a machine 108G can transmit a charging location to a charger 106K. The worksite layout 200 can change daily; therefore, the operation locations 104A-N, the chargers 106A-N, and the charging locations can vary per day. For example, a first worksite layout 200 on Jan. 8, 2023, can be different from a second worksite layout 200 on Jan. 6, 2023. In another example, a first worksite layout 200 on Jan. 8, 2023, can be the same as a second worksite layout 200 on Jan. 7, 2023.

The central controller 112 can receive information between the one or more machines 108 and the one or more chargers 106. The information can indicate the battery metrics of the one or more machines 108 and the charger availability of the one or more chargers 106. For example, a machine 108A can send battery metrics to a central controller 112 and a charger 106K can send a charger availability to the central controller 112. Using the information, the path calculator 310 can calculate a best path 202 for the machine 108A to reach the charger 106K.

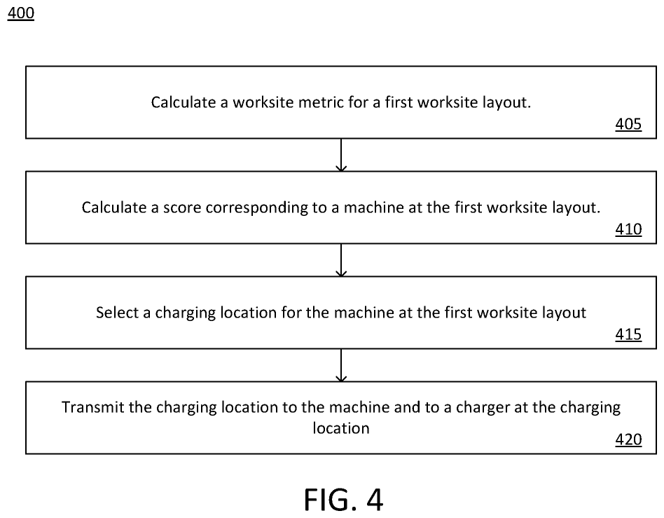

FIG. 4 depicts a 400 method to implement worksite dynamic charging for the worksite and microgrid. The method 400 can be performed by, using, or for system 100. The method 400 can include calculating a worksite metric for a worksite layout (e.g., worksite layout 200) at step 405. The method 400 can include calculating a score corresponding to a machine (e.g., machines 108A-N) at the worksite layout at step 410. The method 400 can include selecting a charging location (e.g., charging locations 204A-N) for the machine at the worksite layout at step 415. The method 400 can include transmitting the charging location to the machine and to a charger (e.g., chargers 106A-N) at the charging location at step 420.

At step 405, the method 400 can include calculating, by the central controller 112, the worksite metric for the worksite layout. The worksite metric can be based on a worksite cost and a historic worksite metric during a previous time period. The worksite layout can change per day, week, month, or year among others. Prior to calculating the worksite metric, the method 400 can include calculating, by the central controller 112, the worksite cost, based on a difference between a total cost and an amount of energy spent by the machine to reach the charger at the second worksite layout, during the previous time period and calculating, by the central controller 112, the historic worksite metric based on a difference between a total amount of work and an amount of productive work at the second worksite layout, during the previous time period. For example, the central controller 112 can access memory 116 to receive worksite costs and historic worksite metrics during a previous time period. The central controller 112 can calculate the worksite metric based on the worksite cost and historic worksite metric to make a prediction for the worksite layout 200.

At step 410, the method 400 can include calculating, by the system processor 114 or the central controller 112, the score corresponding to the machine at the worksite layout. Prior to calculating the score, the method 400 can include receiving, by the distributed controller 110 or the machine processor 306, a machine criticality at the first worksite layout corresponding to the machine, a queue at the charger, a charger connection success rate, and a time to charge based on a cost of energy from a central controller. The system processor 114 or the central controller 112 may calculate the score corresponding to the machine, according to the machine criticality, the queue, the charge connection success rate, and the time to charge. The distributed controller 110 can send the score to the charger and receive an acceptance of the score by the charger. The method 400 can include transmitting, by the distribute controller 110, a signal to the machine. The signal can direct the machine to proceed to the charger of the received acceptance. For example, a distributed controller 100 can receive an acceptance of a score from charger 106K and the distributed controller 110 can send a signal to allow a machine 108G to proceed to the charger 106K.

The method 400 can include broadcasting, by the central controller 112, charger information of the charger of the received acceptance to a plurality of machines. The charger information can indicate availability status and power availability. The method 400 can include receiving, by the central controller, a plurality of bids from the plurality of machines. Each bid in the plurality of bids can indicate battery metrics and a request of the corresponding machine. The method 400 can include determining, by the central controller 112, one bid in the plurality of bids corresponding to the charger information to charge the corresponding machine.

At step 415, the method 400 can include selecting, by the charger selector 302 of the distributed controller 110 or the central controller 112 a charging location for the machine at the first worksite layout, according to the score and the worksite metric. The charging location can be based on battery metrics of the machine and an availability of chargers. The battery metrics can indicate at least one of a state of charge, a state of health, a voltage, charging time, or safety parameters. Prior to selecting the charging location, the method 400 can include determining, by the location selector 308 of the central controller 112, the charging location based on the first worksite layout, movement of materials, and movement of the machine. The method 400 can include determining, by the path calculator 310 of the central controller 112, the charger according to the charging location, and a path (e.g., paths 202A-N) to the charger according to the worksite layout. The method 400 can include transmitting, by the machine processor 306 of the distributed controller 110, a signal to the machine. The signal can indicate that the machine follow the path to the charger. The signal can include information corresponding to load cycles and energy generation of the charge based on the previous time period.

At step 420, the method 400 can include transmitting, by the distributed controller 110, the charging location to the machine and to a charger at the charging location at the first worksite layout. The method 400 can include receiving, by the machine processor 306 of the distributed controller 110, information between the one or more machines and the one or more chargers from a central controller. The information can indicate battery metrics of the one or more machines and charger availability of the one or more chargers. The method 400 can include computing, by the system processor 114 or the central controller 112, using a linear optimizer, a new charger location for a future time period, according to the worksite cost and the historic worksite metric. In response to computing the new charging location, the method 400 can include determining, by the by the distributed controller 110 or the central controller 112, a third worksite layout based the new charger location.

### INDUSTRIAL APPLICABILITY

The disclosed embodiments may be application to any geographic optimization based system or solution. For example, the disclosed embodiments may be applicable or applied to a worksite, such as an excavation site, a mining site, a demolition site, or any other type of industrial worksite, charging locations, charging sites, electrical power grid, a machine, such as a bulldozer, a forklift, or any other type of machinery, a generator, a transformer, or any other type of electrical utility. The disclosed embodiments may be applicable to worksites which include various types of heavy machinery designed to execute tasks throughout the worksite to maximize efficiency and productivity while reducing costs at the worksite. The disclosed distributed controller 110 may be provided to increase efficiency by selecting optimal paths 202 for one or more machines 108 to travel to the selected charger 108A or selected charging location 204A. For example, because the distributed controller 110 receives calculated metrics (e.g., load metrics, worksite metrics, worksite cost) from the central controller 112, the distributed controller 110 can organize each machine 108A in the one or more machines 108 to travel to a respective charger 106A to reduce the idle times of the machines 108.

In various embodiments of the present solution, the distributed controller 110 can communicate with the central controller 112 to use one or more calculated metrics to determine a worksite layout 200 for a future time period. By exchange metrics based on the chargers 106 and the machines 108, the distributed controller 110 can continuously select the best paths 202, charging locations 204, and chargers 106 in each worksite layout 200 during a project or task at the worksite. The worksite layout 200 can change per day, week, month, or year based on the project or the task. This, the distributed controller 110 and the central controller 112 can determine the most optimal worksite layout 200 to reduce cost, maximize productivity, and maximize efficiency at the worksite.

What is claimed:

1. A method, comprising:
calculating, by one or more controllers, a worksite metric for a first worksite layout, wherein the worksite metric is based on a worksite cost and a historic worksite metric during a previous time period, wherein the first worksite layout differs from a second worksite layout;
calculating, by the one or more controllers, a score corresponding to a machine at the first worksite layout;
selecting, by the one or more controllers, a charging location for the machine at the first worksite layout, according to the score and the worksite metric; and
transmitting, by the one or more controllers, a first signal corresponding to the charging location to the machine, and a second signal to a charger at the charging location.

2. The method of claim 1, wherein calculating the worksite metric for the first worksite layout comprises:
calculating, by the one or more controllers, the worksite cost, based on a difference between a total cost and an amount of energy spent by the machine to reach the charger at the second worksite layout, during the previous time period; and
calculating, by the one or more controllers, the historic worksite metric based on a difference between a total amount of work and an amount of productive work at the second worksite layout, during the previous time period.

3. The method of claim 1, wherein selecting the charging location is based on battery metrics of the machine and an availability of chargers, wherein the battery metrics indicates at least one of a state of charge, a state of health, a voltage, charging time, or safety parameters.

4. The method of claim 1, wherein selecting a charging location for the machine at the first worksite layout further comprising determining, by the one or more controllers, the charging location based on the first worksite layout, movement of materials, and movement of the machine.

5. The method of claim 4, further comprising:
selecting, by the one or more controllers, the charger according to the charging location, and a path to the charger according to the first worksite layout; and
transmitting, by the one or more controllers, the first signal to the machine, wherein the first signal indicates the machine follow the path to the charger, wherein the first signal comprises information corresponding to load cycles and energy generation of the charge based on the previous time period.

6. The method of claim 1, wherein transmitting, the charging location to the machine and to the charger at the charging location at the first worksite layout further comprising receiving, by the one or more controllers, information between one or more machines and one or more chargers from a central controller, wherein the information indicates battery metrics and charger availability.

7. The method of claim 1, further comprising:
computing, by the one or more controllers, using a linear optimizer, a new charger location for a future time period, according to the worksite cost and the historic worksite metric; and
determining, by the one or more controllers, a third worksite layout based the new charger location.

8. The method of claim 1, wherein calculating, the score further comprises:
receiving, by the one or more processors, a machine criticality at the first worksite layout corresponding to the machine, a queue at the charger, a charger connection success rate, and a time to charge based on a cost of energy from a central controller; and
calculating, by the one or more controllers, the score corresponding to the machine, according to the machine criticality, the queue at the charger, the charge connection success rate, and the time to charge.

9. The method of claim 1, wherein selecting the charging location for the machine at the first worksite layout further comprises:
sending, by the one or more controllers, the score to the charger,
receiving, by the one or more controllers, an acceptance of the score by the charger; and
transmitting, by the one or more controllers, a signal to the machine, wherein the signal directs the machine to proceed to the charger of the received acceptance.

10. The method of claim 9, further comprising:
broadcasting, by the one or more controllers, charger information of the charger of the received acceptance to a plurality of machines, wherein the charger information indicates an availability status and a power availability;
receiving, by the one or more controllers, a plurality of bids from the plurality of machines, wherein each bid in the plurality of bids indicates battery metrics of a corresponding machine and a request by the corresponding machine; and
determining, by the one or more controllers, one bid in the plurality of bids corresponding to the charger information to charge the corresponding machine.

11. A system comprising:
a plurality of machines comprising one or more first machines at a first operation location and one or more second machines at a second operation location;
a plurality of chargers comprising one or more first chargers at a first charging location and one or more second chargers at a second charging location; and
a data processing system comprising:
memory; and
one or more controllers comprising one or more processors, configured to:
calculate a worksite metric for a first worksite layout, the worksite metric based on a worksite cost and a historic worksite metric during a previous time period, wherein the first worksite layout differs from a second worksite layout;
calculate a score corresponding to a first machine of the plurality of machines at the first worksite layout;
select a charging location for the first machine at the first worksite layout, according to the score and the worksite metric; and
transmit a first signal corresponding to the charging location to the first machine, and a second signal to a charger of the plurality of chargers at the charging location.

12. The system of claim 11, wherein, when calculating the worksite metric for the first worksite layout, a central controller of the one or more controllers is configured to:
calculate the worksite cost, based on a difference between a total cost and an amount of energy spent by the first machine to reach the charger at the second worksite layout, during the previous time period; and
calculate the historic worksite metric based on a difference between a total amount of work and an amount of productive work at the second worksite layout, during the previous time period.

13. The system of claim 11, wherein selecting the charging location is based on battery metrics of the machine and an availability of chargers, the battery metrics indicates at least one of a state of charge, a state of health, a voltage, charging time, or safety parameters.

14. The system of claim 11, wherein, when selecting a charging location for the first machine at the first worksite layout, a distributed controller of the one or more controllers is configured to:
determine the charging location based on the first worksite layout, movement of materials, and movement of the machine;
determine the charger according to the charging location and a path to the charger according to the first worksite layout; and
transmit a signal to the first machine, wherein the signal instructs the first machine follow the path to the charger, wherein the signal indicates load cycles and energy generation of the charger based on the previous time period.

15. The system of claim 11, wherein, when transmitting the first signal corresponding to the charging location to the first machine and the second signal to the charger at the charging location a distributed controller of the one or more controllers is configured to receive information between one or more of the plurality of machines and one or more of the plurality of chargers from a central controller, wherein the information indicates battery metrics and charger availability.

16. The system of claim 11, wherein the one or more controllers are further configured to:
compute, using a linear optimizer, a new charger location for a future time period, according to the worksite cost and the historic worksite metric; and
determine a third worksite layout based the new charger location.

17. The system of claim 11, wherein, when calculating the score, a distributed controller of the one or more controllers is configured to:
receive a machine criticality at the first worksite layout corresponding to the first machine, a queue at the charger, a charger connection success rate, and a time to charge; and
calculate the score corresponding to the first machine, according to the machine criticality, the queue at the charger, the charge connection success rate, and the time to charge.

18. The system of claim 11, wherein, when selecting the charging location for the first machine at the first worksite layout, a distributed controller of the one or more controllers is configured to:
send the score to the charger;
receive an acceptance of the score by the charger;
broadcast charger information of the charger of the received acceptance to the plurality of machines, wherein charger information indicates availability status and power availability;
receive a plurality of bids from the plurality of machines, wherein each bid in the plurality of bids indicates battery metrics of a corresponding machine and a request by the corresponding machine; and
determine one bid in the plurality of bids corresponding to the charger information to charge the corresponding machine; and
transmit the first signal to the first machine, wherein the signal directs the machine to proceed to the charger of the received acceptance.

19. The system of claim 11, wherein the one or more controllers comprise:
a central controller configured to:
calculate the worksite metric for the first worksite layout; and
calculate the score corresponding to the first machine of the plurality of machines at the first worksite layout; and
a distributed controller configured to:
select the charging location for the first machine at the first worksite layout, according to the score and the worksite metric; and
transmit the first signal corresponding to the charging location to the first machine, and transmit a second signal to the charger of the plurality of chargers at the charging location.

20. A data processing system comprising:
memory; and
one or more controllers comprising one or more processors, configured to:
calculate a worksite metric for a first worksite layout, the worksite metric based on a worksite cost and a historic worksite metric during a previous time period, wherein the first worksite layout differs from a second worksite layout;
calculate a score corresponding to a first machine of a plurality of machines at the first worksite layout;
select a charging location for the first machine at the first worksite layout, according to the score and the worksite metric; and
transmit a first signal corresponding to the charging location to the first machine, and a second signal to a charger of a plurality of chargers at the charging location.
